(19) United States
(12) Patent Application Publication
(10) Pub. No.: US 2006/0010642 A1
(43) Pub. Date: Jan. 19, 2006

(54) Castor covers

(76) Inventors: Henry J. Nickson, Chicago, IL (US); Jesse J. Evans, Chicago, IL (US)

Correspondence Address: Henry J. Nickson, 7334 S. Eberhart, Chicago, IL, 60619, US

(21) Appl. No.: 10/715,999

(22) Filed: Jul. 2, 2004

(51) Int. Cl. B60B 33/00

(52) U.S. Cl. 16/18 CG

(57) ABSTRACT

The nature of the Castor Cover is to serve as a safety mechanism for the feet of various individuals, as they walk or pass by castors that are not covered. There is nothing new in the art as to which our invention pertains.

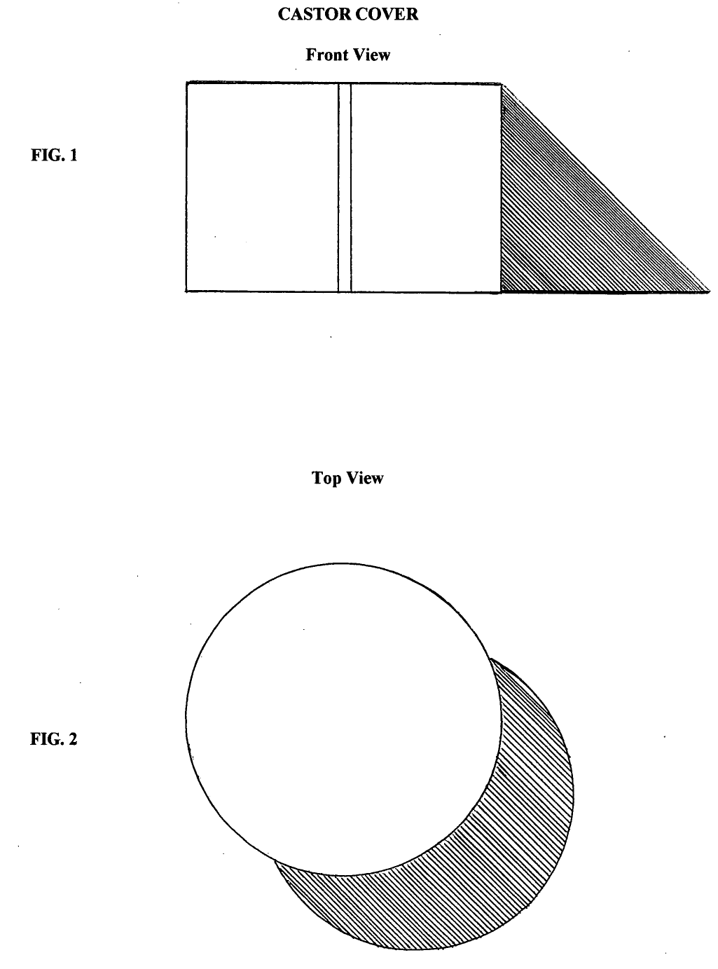

We the above named individuals, being signatories of this application, here-by petition the Commissioner For Patents of the United States Patent and Trademark Office, to allow a non-provisional patent for our invention named Castor Covers. These covers are designed to prevent serious injury to a person's foot after he or she has accidentally stubbed or stricken their toe on an uncovered castor, is by definition a wheel or a set of wheels mounted in a swivel frame used for supporting furniture, such as; beds, chairs, tables, etc. The Castor Cover will also help prevent serious injury to children, whom might accidentally strike their heads on the uncovered castor while playing on the floor.

The Castor Cover is a 12 inch, when expanded, padded cover, held together by Velcro on the ends and wraps around the castors. It is 4 inches in height. A drawing is included with the application.

1. We the above named inventors, Henry J. Nickson and Jesse J. Evans, here by claim all rights to produce, manufacture and distribute the invention here-in named Castor Covers.
